(19) United States
(12) Patent Application Publication
(10) Pub. No.: US 2010/0147000 A1
(43) Pub. Date: Jun. 17, 2010

(54) ADJUSTABLE BULKHEAD PLATE FOR BUS ROOFTOP AIR CONDITIONER

(75) Inventor: Alan B. Swartz, York, PA (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/600,892

(22) PCT Filed: May 25, 2007
(86) PCT No.: PCT/US07/12568

§ 371 Date: Nov. 19, 2009

(51) Int. Cl. B60H 1/32; B23P 11/00

(52) U.S. Cl. 62/244; 29/525.01

(57) ABSTRACT

To facilitate various distances between a bus rooftop mounted condenser and the air conditioning components below the rooftop, a bulkhead plate is provided with a pair of spaced tubes whose vertical positions can be selectively adjusted to accommodate any possible installation requirement of various possible rooftop shapes. A standard tube and fixture assembly can therefore be used by adjusting the respective distances that it extends above and below the bulkhead plate. A compression fitting is provided to obtain a leak proof fluid connection between the components.

### BACKGROUND OF THE INVENTION

This invention relates generally to bus air conditioning systems and, more particularly, to a method and apparatus for connecting a rooftop condenser to an evaporator and compressor disposed therebelow.

A typical bus air conditioning system includes one or more condenser units that are mounted on the bus rooftop, and with one or more evaporator units disposed within the internal space of the bus. The compressor is typically mounted in the engine compartment which is located below the interior of the bus. The condenser, evaporator and compressor are necessarily fluidly interconnected to provide for the flow of refrigerant through the air conditioning system.

A common approach for fluidly connecting the condenser unit to the evaporator and compressor is by way of a bulkhead plate which includes tubes and interconnecting fixtures which allow for the bulkhead plate to be placed on the bus rooftop, with the condenser tubes extending downwardly through the bulkhead plate and the bus rooftop to connect to tubes that pass to the evaporator and the compressor, respectively. It is important that these connections be made in such a manner as to provide a water tight seal between the interior and exterior of the bus as they pass through the roof.

Because of the varying configurations of the bus rooftops, i.e. from flat to curved or angled, the distance that the connecting tubes must extend above the bulkhead plate varies substantially. Accordingly, it has been necessary to customize the bulkhead plate attachments for each type of bus rooftop that is encountered. That is, it has been necessary to measure the distance between the bus rooftop and the mounted condensing unit and to tailor the length of the tubing and the fixtures accordingly. This is not only labor intensive, but also is subject to error and waste.

### SUMMARY OF THE INVENTION

Briefly, in accordance with one aspect of the invention, a bulkhead plate arrangement is provided with a tubing and connector combination which is adjustable in its length that extends above the bulkhead plate so as to accommodate any of the variable distances between the bus rooftop and the condenser unit.

By yet another aspect of the invention, the tubing that passes through an opening in the bulkhead plate is of sufficient length to accommodate any of the installation requirements, and the tubing height above the plate is adjustable to accommodate a particular installation requirement, with the remaining portion of the tube being disposed below the bulkhead plate where the installation requirements are flexible.

By another aspect of the invention, the tube is fixed in its position for desired length by way of a compression fitting that is disposed below the plate. The compression fitting in addition to providing a leak-free refrigerant flowpath, ensures that a water tight seal is maintained between the interior and exterior of the bus rooftop.

In the drawings as hereinafter described, a preferred embodiment is depicted; however, various other modifications and alternate constructions can be made thereto without departing from the scope of the invention.

### BRIEF DESCRIPTION OF THE DRAWINGS

FIG. 1 is a front elevational view, partially sectioned, of a condensing unit mounted on the top of a bus in accordance with the prior art.

FIG. 2 is a front elevational view of an embodiment of the present invention.

FIG. 3 is a front view thereof as shown in a partially unassembled condition.

FIG. 4 shows the piping as assembled in two possible extreme positions in accordance with the present invention.

FIGS. 5 and 6 show the present invention as installed in flat, and curved bus types, respectively.

### DETAILED DESCRIPTION OF THE INVENTION

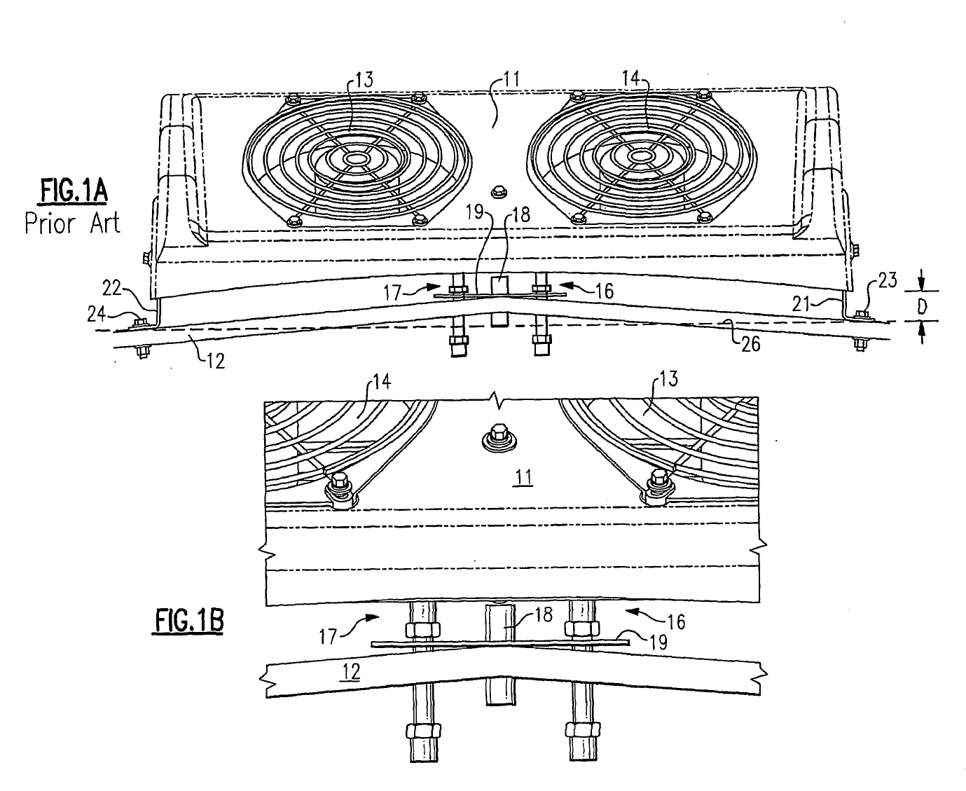

Shown in FIG. 1 is a conventional installation of a condensing unit 11 as mounted on a bus rooftop 12.

The condenser 11 includes the transversely spaced fans 13 and 14 which operate to circulate outdoor air over a condenser coil (not shown) for purposes of condensing the refrigerant in an air conditioning system. As part of the air conditioning circuit, refrigerant is made to flow by a compressor, to the condenser and then to the expansion device and an evaporator, and then back to the compressor. The compressor, expansion device and evaporator are normally located within the confines of the bus and it is therefore necessary to provide fluid communication between those components and the condenser mounted on the bus rooftop. This is accomplished by a pair of refrigerant tube and fixture assemblies 16 and 17 as shown in FIG. 1. In addition, it is necessary to provide electrical power to the condenser 11 from a location within the bus rooftop 12. This is accomplished by way of a centrally located tube 18 through which electrical wires may be passed and then properly insulated and sealed to prevent moisture from passing therethrough. The bulkhead plate 19 is used as an interface between the tube and fixture assembly 16 and 17 and the bus rooftop 12, as shown.

The condenser 11 is supportable mounted on the bus rooftop by a pair of laterally spaced, brackets 21 and 22 that are secured near the outer edges of the bus rooftop 12 by fasteners 23 and 24, respectively.

The bus rooftop 12 as shown is angled upwardly from each side to rise to a peak at the center. In this regard, it should recognized that the bus rooftops may take various other shapes such as a fiat roof as indicated by the dashed lines 26 or a curved shape, wherein it gradually rises as it extends towards the center than falls at the other side, but does not have an angular peak as shown in FIG. 1.

The applicants have recognized that with the different shaped roofs, the distance between the top of the roof and the bottom of the condenser 11 will vary substantially. For example, that distance would be minimal when the condenser 11 is mounted on an angled roof as shown and would be at a maximum when it is mounted on flat roof. The difference in height of the condenser 11 above the bus rooftop 12 would vary by a distance D between those two installations.

Because of this variability, it is desirable to provide tube and fixture assemblies 16 and 17 which can be selectively, and easily adjusted to accommodate the particular installation. Such an apparatus is shown in FIGS. 2-4.

In accordance with one embodiment of the present invention, the bulkhead plate 19 is provided with tube and fixture assemblies 31 and 32 as shown. Each of the tube and fixture assemblies 31 and 32 is substantially identical to the other. They include respective tubes 33 and 34 having female connectors 36 and 37 connected to their respective ends and female connectors 38 and 39 connected to their respective outside ends. Connection of these female connectors to the tubes is in a permanent fashion such as by brazing or the like. Each of the tubes 33 and 34 is free to move axially (i.e. vertically) through openings formed in the bulkhead plate 19. While the connectors 38 and 39 are shown as female connectors, they may, as well be male connectors which mate with female connectors.

Secured to the underside of the bulkhead plate 19 are the respective compression fittings 41 and 42. The compression fittings 41 and 42 are brazed at their upper ends to the bottom of brass plate 19 with their central axes being coincident with the axes the openings through the plate 19. The lower end of the compression fittings 41 and 42 have male threads 43 and 44 as shown.

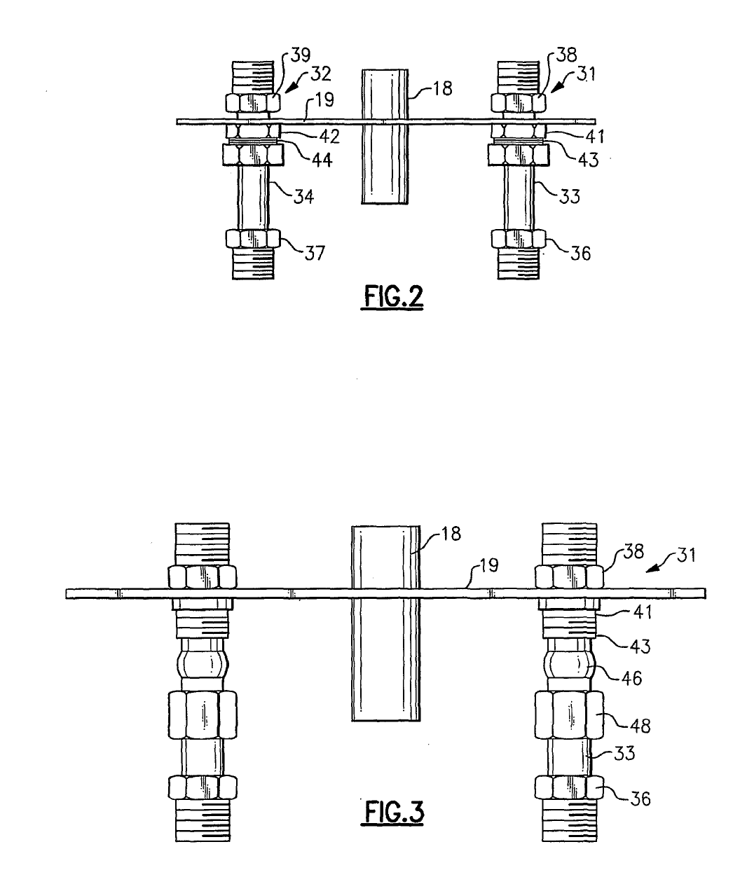

Slideably mounted on the respective tubes 33 and 34 are the respective compression rings 46 and 47 (see FIG. 3), as well as compression fasteners 48 and 49. The compression rings 46 and 47 are arcuately formed on their outer surface such that they sealingly engage an inner surface of the respective compression fittings and compression fasteners when the compression fasteners (48 and 49) is threadable engaged and tightened against the respective male threads 43 and 44. It should, of course, be understood that the compression fittings may have a female thread that mates with a male thread of the compression fasteners.

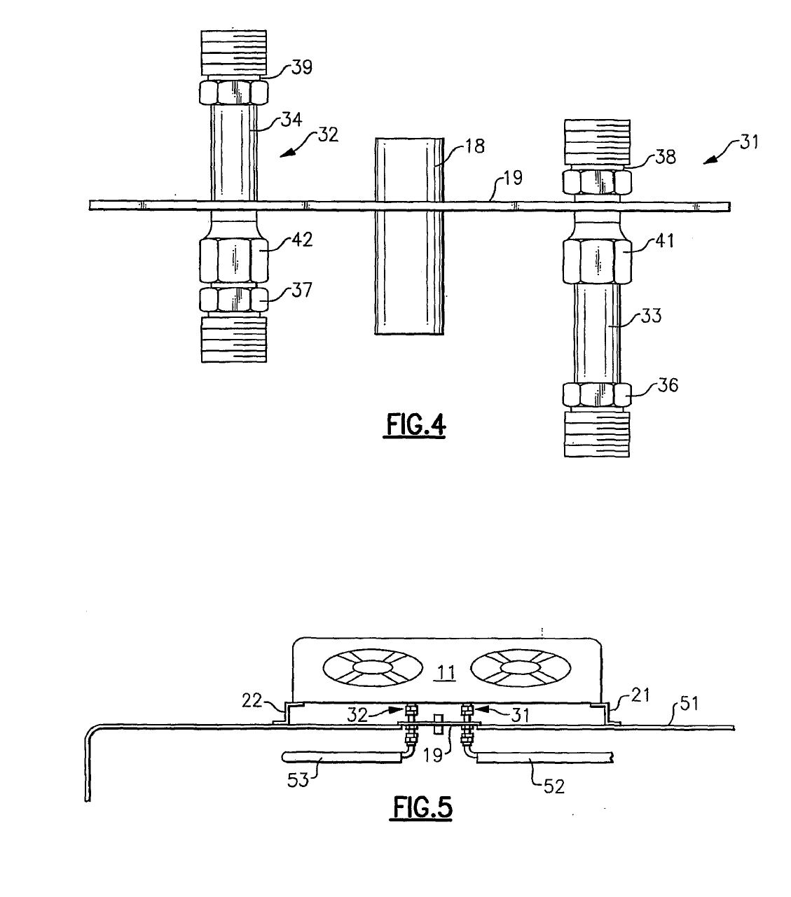

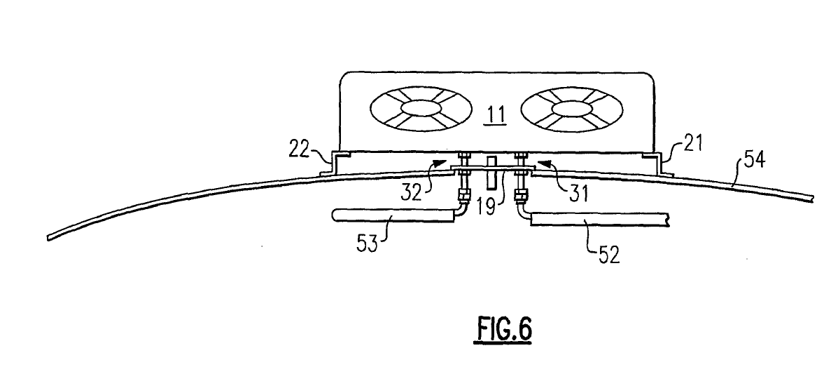

With the above described arrangement, it will be understood that the tubes 33 and 34 may be adjusted to any position between the two extreme positions as shown in FIG. 4. That is, the tube 33 is adjusted to the extreme downward position such that the minimum distance is provided between the bulkhead plate 19 and the end of the outside female connector 38. Similarly, the tube 34 is adjusted to be in the extreme upper position wherein the distance between the top of the bulkhead plates 19 and the end of the outdoor female connector 39 is at a maximum. In this way, the parts as described can be standardized while at the same time being adaptable to various installation requirements for various types of bus rooftops. Examples can be seen in FIGS. 5 and 6.

In FIG. 5 the bus rooftop 51 is flat such that the distance between the bottom of the condenser 11 and the top of the rooftop 51 is at a maximum. The tube and fixture assemblies 31 and 32, together with their bulkhead plate 19 are mounted in a central opening 52 of the bus rooftop as shown, with the bulkhead plate 19 being sealingly attached, such as by an adhesive or the like, to the top of the rooftop 51. The respective tubes 33 and 34 of the tube and fixture assemblies 31 and 32 are then axially adjusted to the proper height and their outdoor male connectors are secured to a threaded female fixture of the condenser 11. The respective compression rings and compression nuts are then secured at the lower side of the bulkhead plate 19 to provide leak proof flow paths between the condenser 11 and the evaporator and compressor hoses 52 and 53, respectively.

In the FIG. 6 installation, the rooftop 54 is of the curved type such that the distance between the top of the rooftop 54 and the bottom of the condenser 11 is at a minimum. Accordingly, the tube and fixtures assemblies 31 and 32 are adjusted such that the distance that the respective tubes 33 and 34 extend above the plate 19 is at a minimum and the distance that they extend below the plate 19 is at a maximum. Again, a leak proof flow path is provided from the condenser 11 to each of the evaporator hose and condenser hose 52 and 53.

In this manner, a standard identical assembly can be adjustably installed to accommodate any of various rooftop configurations in a simple and efficient manner to obtain a robust interconnection between the condenser 11 on the outer side of the bus and the other air conditioning components within the bus.

While the present invention has been particularly shown and described with reference to the particular exemplary embodiment as illustrated in the drawings, it will be understood by one skilled in the art that various modifications or changes, some of which have been discussed herein, may be effected therein without departing from the spirit and scope of the invention.

We claim:

1. A bulkhead plate connection for a bus air conditioning system of the type having a condenser mounted on the bus rooftop and at least one component being fluidly connected thereto and located below the bus rooftop comprising:
a plate to be positioned between the condenser and the bus rooftop, said plate having upper and lower sides and at least one opening formed therethrough;
a first threaded connector rigidly secured around said opening on said lower side;
a tube slideably disposed in said at least one opening and having attached at an upper end a threaded connector for attachment to a line to said condenser and having attached at a lower end a threaded connector for attachment to a line to said at least one component;
a compression ring slideably disposed on said tube and having one end engageable with an internal surface of said threaded connector to provide a sealing relationship therebetween and having another end;
a second threaded connector slideably mounted on said tube and threadably engageable with said first threaded connector to cause said compression ring to engage said first threaded connector internal surface and said compression ring other end to engage an internal surface of said second threaded connector;
wherein said tube is of sufficient length and is adjustable in its extension above said plate to accommodate various distances between the bus rooftop and the condenser.

2. A bulkhead plate connection as set forth in claim 1 wherein said at least one opening includes two openings and each opening is provided with a first threaded connector, a tube, a compression ring and a second threaded connector and further wherein said at least one component includes an evaporator and a compressor.

3. A bulkhead plate connection as set forth in claim 1 wherein said bulkhead plate is mounted on an upper surface of the bus rooftop in such a manner as to cover an opening through which said first threaded connector, compression ring and second threaded connector extend downwardly therethrough.

4. A bulkhead plate as set forth in claim 1 wherein said compression ring has an outer surface that is arcuate in shape.

5. A bulkhead plate connector as set forth in claim 1 wherein said first threaded connector is a male connector and said second threaded connector is a female connector.

6. A method of fluidly attaching a condenser on a bus rooftop to at least one other air conditioning component disposed below the rooftop comprising the steps of:
providing an opening in the bus rooftop;
providing a plate that is larger than said opening and having at least one opening formed therein;
providing a tube in said at least one opening with the tube being slideably disposed in said at least one openings;
providing a compression fitting in coaxial alignment with said at least one said plate opening and attaching it to the bottom of the plate;
providing a compression ring and a compression fastener and slideably mounting them on the tube;
providing upper and lower end couplings on said tube with said upper end coupling being fluidly and sealingly attachable to the condenser and said lower end coupling being fluidly and sealingly attached to an air conditioning component;
adjusting the axial position of the tube to accommodate the particular installation requirement;
sealingly attaching said compression ring and compression fastener to said compression fitting; and
sealingly attaching said upper and lower end couplings to the respective condenser and said at least one other air conditioning component.

7. A method as set forth in claim 6 wherein said at least one opening includes two openings and each opening is provided with a compression fitting, a tube, a compression ring and a compression fastener and further wherein said at least one component includes an evaporator and a compressor.

8. A method as set forth in claim 6 wherein said bulkhead plate is mounted on an upper surface of the bus rooftop in such a manner as to cover an opening through which said tube extends downwardly therethrough.

9. A method as set forth in claim 6 wherein said compression ring has an outer surface that is arcuate in shape.

10. A method as set forth in claim 6 wherein said compression fitting includes a male threaded member and said compression fastener includes a female threaded member.
